(19) United States
(12) Patent Application Publication
(10) Pub. No.: US 2026/0333078 A1
(43) Pub. Date: Oct. 22, 2026

(54) ARTIFICIAL INTELLIGENCE COMMUNICATION METHOD AND APPARATUS, AND STORAGE MEDIUM

(71) Applicant: Beijing Xiaomi Mobile Software Co., Ltd., Beijing (CN)

(72) Inventor: Qin MU, Beijing (CN)

(73) Assignee: Beijing Xiaomi Mobile Software Co., Ltd., Beijing (CN)

(21) Appl. No.: 19/483,673

(22) PCT Filed: May 15, 2023
(86) PCT No.: PCT/CN2023/094362

§ 371 Date: Nov. 12, 2025

(51) Int. Cl. H04W 24/02

(52) U.S. Cl. CPC H04W 24/02

(57) ABSTRACT

Disclosed are an artificial intelligence (AI) communication method and apparatus, and a storage medium. The artificial intelligence communication method comprises: determining a processing time, wherein the processing time is the time for switching an AI model corresponding to an AI function or model identifier; and on the basis of the processing time, switching the AI model corresponding to the AI function or model identifier. In the present disclosure, a processing time is determined, such that the determination of a processing time for switching an AI model corresponding to an AI function or model identifier is realized.

### CROSS-REFERENCE TO RELATED APPLICATION

The application is a U.S. National Stage of International Application No. PCT/CN2023/094362 filed on May 15, 2023, the entire content of which is incorporated herein by reference.

### TECHNICAL FIELD

The present disclosure relates to the technical field of communication, and in particular, to an artificial intelligence (AI) communication method, apparatus and storage medium.

### BACKGROUND

In recent years, AI technology has made continuous breakthroughs in many fields. In the related art, AI technology is introduced in the wireless air interface to assist in improving the transmission technology of the wireless air interface. Currently, the application of AI technology is supported in the wireless air interface for communication processing, including the training of the AI model corresponding to the model identification and the inference application of the model.

### SUMMARY

The present disclosure provides an AI communication method, apparatus and storage medium.

According to the first aspect of embodiments of the present disclosure, there is provided an AI communication method, which is performed by a terminal and includes:
determining a processing time, where the processing time is a time for switching an AI function or an AI model corresponding to a model identification; and switching the AI function or the AI model corresponding to the model identification based on the processing time.

According to the second aspect of the embodiments of the present disclosure, there is provided an AI communication method, which is performed by a network device, and the method includes: determining a processing time, where the processing time is a time for a terminal to switch an AI function or an AI model corresponding to a model identification.

According to the third aspect of the embodiments of the present disclosure, there is provided an AI communication apparatus, including:
a processing unit, configured to determine a processing time, where the processing time is a time for switching an AI function or an AI model corresponding to a model identification; and switch the AI function or the AI model corresponding to the model identification based on the processing time.

According to the fourth aspect of the embodiments of the present disclosure, there is provided an AI communication apparatus, which is performed by a network device and includes:
a processing unit, configured to determine a processing time, where the processing time is a time for a terminal to switch an AI function or an AI model corresponding to a model identification.

According to the fifth aspect of the embodiments of the present disclosure, there is provided an AI communication apparatus, including:
a processor; and a memory for storing instructions executable by the processor;
where the processor is configured to execute the AI communication method described in the first aspect or any one of the implementations of the first aspect.

According to the sixth aspect of the embodiments of the present disclosure, there is provided an AI communication apparatus, including:
a processor; a memory for storing instructions executable by the processor;
where the processor is configured to execute the AI communication method described in the second aspect or any one of the implementations of the second aspect.

In the seventh aspect of the embodiments of the present disclosure, a storage medium is provided, in which instructions are stored. When the instructions in the storage medium are executed by a processor of a terminal, the terminal is enabled to perform the method described in the first aspect or any one of the implementations of the first aspect.

In the eighth aspect of the embodiments of the present disclosure, a storage medium is provided, in which instructions are stored. When the instructions in the storage medium are executed by a processor of a network device, the network device is enabled to perform the method described in the first aspect or any one of the implementations of the first aspect.

According to the ninth aspect of the embodiments of the present disclosure, an artificial intelligence communication system is provided, the system including: a terminal, configured to perform the method described in the first aspect or any one of the implementations of the first aspect; and a network device, configured to perform the method described in the second aspect or any one of the implementations of the second aspect.

It should be understood that the above general description and the following detailed description are exemplary and explanatory only and are not intended to limit the present disclosure.

### BRIEF DESCRIPTION OF THE DRAWINGS

The accompanying drawings, which are incorporated in and constitute a part of this description, illustrate embodiments consistent with the present disclosure and, together with the description, serve to explain the principles of the present disclosure.

FIG. 1 is a schematic diagram showing a wireless communication system according to an exemplary embodiment.

FIG. 2a is a flowchart showing an AI communication method according to an exemplary embodiment.

FIG. 2b is a flowchart showing another AI communication method according to an exemplary embodiment.

FIG. 2c is a flowchart showing another AI communication method according to an exemplary embodiment.

FIG. 2d is a flowchart showing another AI communication method according to an exemplary embodiment.

FIG. 2e is a flowchart showing another AI communication method according to an exemplary embodiment.

FIG. 2f is a flowchart showing another AI communication method according to an exemplary embodiment.

FIG. 2g is a flowchart showing another AI communication method according to an exemplary embodiment.

FIG. 3a is a flowchart showing an AI communication method according to an exemplary embodiment.

FIG. 3b is a flowchart showing another AI communication method according to an exemplary embodiment.

FIG. 4 is a schematic diagram showing an architecture of an AI communication system according to an exemplary embodiment.

FIG. 5a is a structural block diagram of an AI communication apparatus according to an exemplary embodiment.

FIG. 5b is a structural block diagram of another AI communication apparatus according to an exemplary embodiment.

FIG. 5c is a structural block diagram of another AI communication apparatus according to an exemplary embodiment.

FIG. 5d is a structural block diagram of an AI communication apparatus according to an exemplary embodiment.

FIG. 5e is a structural block diagram of another AI communication apparatus according to an exemplary embodiment.

FIG. 5f is a structural block diagram of another AI communication apparatus according to an exemplary embodiment.

FIG. 6 is a block diagram of an apparatus for AI communication according to an exemplary embodiment.

FIG. 7 is a block diagram of an apparatus for AI communication according to an exemplary embodiment.

### DETAILED DESCRIPTION

Here, exemplary embodiments are described in detail, examples of which are shown in the accompanying drawings. When the following description refers to the drawings, unless otherwise indicated, the same numbers in different drawings represent the same or similar elements. The implementations described in the following exemplary embodiments do not represent all implementations consistent with the present disclosure.

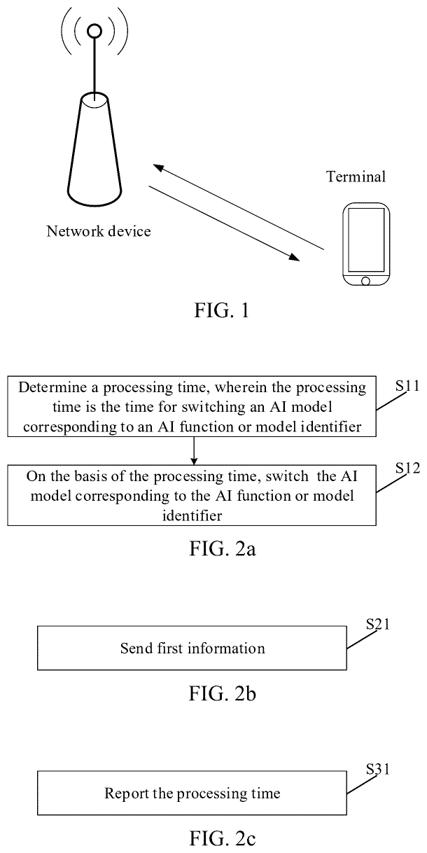

The communication method of the embodiments of the present disclosure can be applied to the wireless communication system shown in FIG. 1. Referring to FIG. 1, the wireless communication system includes a network device and a terminal. The terminal is connected to the network device through wireless resources and performs data transmission.

It is understandable that the wireless communication system shown in FIG. 1 is only for schematic illustration, and the wireless communication system may also include other network devices, such as a core network device, a wireless relay device, and a wireless backhaul device, which are not shown in FIG. 1. The embodiments of the present disclosure do not limit the number of network devices and terminals included in the wireless communication system.

It can be further understood that the wireless communication system of the embodiments of the present disclosure is a network that provides wireless communication functions. The wireless communication system can adopt different communication technologies, such as code division multiple access (CDMA), wideband code division multiple access (WCDMA), time division multiple access (TDMA), frequency division multiple access (FDMA), orthogonal frequency-division multiple access (OFDMA), single carrier frequency division multiple access (single carrier FDMA, SC-FDMA), carrier sense multiple access/collision avoidance (Carrier Sense Multiple Access with Collision Avoidance). According to the capacity, rate, delay and other factors of different networks, the network can be divided into 2G (English: generation) network, 3G network, 4G network or future evolution network, such as 5G network, 5G network can also be called new wireless network (New Radio, NR). For the convenience of description, the present disclosure sometimes simply refers to a wireless communication network as a network.

Further, the network device involved in the present disclosure may also be referred to as a wireless access network device. The wireless access network device may be: a base station, an evolved node B (base station), a home base station, an access point (AP) in a wireless fidelity (WIFI) system, a wireless relay node, a wireless backhaul node, a transmission point (TP) or a transmission and reception point (TRP), etc. It may also be a gNB in an NR system, or it may also be a component or a part of the base station. It should be understood that in the embodiments of the present disclosure, the specific technology and specific device form adopted by the network device are not limited. In the present disclosure, the network device may provide communication coverage for a specific geographical area, and may communicate with a terminal located in the coverage area (cell). In addition, when it is a vehicle-to-everything (V2X) communication system, the network device may also be a vehicle-mounted device.

Furthermore, the terminal involved in the present disclosure may also be referred to as a terminal device, a user equipment (UE), a mobile station (MS), a mobile terminal (MT), etc., which is a device that provides voice and/or data connectivity to users. For example, the terminal may be a handheld device with a wireless connection function, a vehicle-mounted device, etc. At present, some examples of terminals are: a smart phone, a customer premises equipment (CPE), a pocket computer (Pocket Personal Computer, PPC), a handheld computer, a personal digital assistant (PDA), a laptop computer, a tablet computer, a wearable device, or a vehicle-mounted device, etc. In addition, when it is a vehicle-to-everything (V2X) communication system, the terminal device may also be a vehicle-mounted device. It should be understood that the embodiments of the present disclosure do not limit the specific technology and specific device form adopted by the terminal.

In recent years, artificial intelligence (AI) technology has made continuous breakthroughs in many fields. The AI technology is gradually cross-penetrating with other disciplines, providing new directions and methods for the development of different disciplines.

In the related art, the 3rd Generation Partnership Project (3GPP) has set up a research project on artificial intelligence technology in the wireless air interface. The project aims to study the introduction of AI technology in the wireless air interface and explore how AI technology can assist in improving the transmission technology of the wireless air interface.

In the research on AI communications, AI use cases may include: AI-based channel state information (CSI) enhancement, AI-based beam management, and AI-based positioning, etc.

It is understandable that AI use cases can also be called AI features, that is, a communication scenario in which a certain communication operation is performed based on AI to achieve a certain purpose. For example, AI is used to predict channel information in the time domain. AI is used to perform beam management in the spatial domain, etc. Usually, one AI feature is defined in the protocol.

In the above AI use cases, multiple AI functions are defined for one AI use case. In one AI use case, different AI functions may be set. Taking the use case of AI-based CSI enhancement as an example, assuming that this use case includes two AI functions, AI function #1 may support prediction of an ID of the best beam, and AI function #2 may support prediction of the best beam and a measurement result of the corresponding beam.

For AI functions, they are implemented through the corresponding AI models. During the communication processing, if the AI function is to be switched, it may involve the switching of the AI model, or it may not involve the switching of the AI model. For example, the implementation of AI function 1 # may be implemented through model A, and the implementation of AI function 2 # may be implemented through model B. If the AI function is to be switched from AI function 1 # to AI function 2 #, it is necessary to switch model A to model B accordingly. Furthermore, if AI function 1 # is implemented through model C, and AI function 2 # can also be implemented through model C, then there is no need to switch the corresponding model when the AI function is switched from AI function 1 # to AI function 2 #. When the AI model switch occurs, the terminal needs to reload the AI model from the storage. The model processing is interrupted when loading the new model and completing the model switch. The time of the model processing interruption is called an interruption time.

Based on this, the interruption time may be different for different mapping of AI models to AI functions. Some interruption time may be equal to the processing time, while others may be longer than the processing time. In addition, the number of AI models corresponding to each AI function may be different, which may also lead to different processing time when switching AI functions.

Regarding the processing time when switching AI models, there are also the following scenarios: when the AI model is deployed on the terminal side, the terminal may register the model with the network device, and the terminal may obtain one model identification (model ID). The model ID can be set for both the logical model and the physical model.

It can be understood that the physical model is the AI model that is actually used to implement AI functions, and the logical model is the AI model that virtualizes the functions and conditions implemented by the physical model.

Therefore, when the network device indicates to switch the logical model based on the model identification, it may correspond to the switching of different physical models under the same model identification, or it may not cause the switching of the physical model. Then, the interruption time brought by model switching will also be different. In addition, the number of physical models corresponding to one model identification is different, and then the processing time for model switching is also different.

In the related art, when switching the AI function or the AI model corresponding to the model identification, the processing time corresponding to the switching process is not clear, and thus the communication processing based on switching of the AI function or switching of the AI model corresponding to the AI model identification is not clear, affecting the communication performance.

Based on this, the present disclosure provides an AI communication method, which clarifies the processing time corresponding to the switching of the AI function or the switching of the AI model corresponding to the model identification, and switches the AI function or switches the AI model corresponding to the model identification based on the processing time, thereby improving the communication performance.

It should be noted that, for the convenience of description, the switching time used for switching the AI function or the AI model in each embodiment of the present disclosure is described in terms of processing time.

It should be noted that the representation form of the processing time involved in each embodiment of the present disclosure may include at least one of the following: absolute time, communication time unit and AI time unit.

Among them, the absolute time includes: seconds, milliseconds, microseconds, etc.

The communication time unit includes: Orthogonal Frequency Division Multiplexing (OFDM) symbols, slots, subslots, and sampling intervals of OFDM symbols.

The AI time unit is used to describe the time unit of AI communication. It can be understood that the AI time unit is obtained by definition and is a basic time unit used to measure AI processing tasks.

The processing time involved in the embodiments of the present disclosure can be represented based on at least one of the absolute time, communication time unit and AI time unit involved above. It should be noted that in some special scenarios, the switching time between different AI functions or AI models may be 0.

In the embodiments of the present disclosure, the AI communication method involved in the present disclosure is described below.

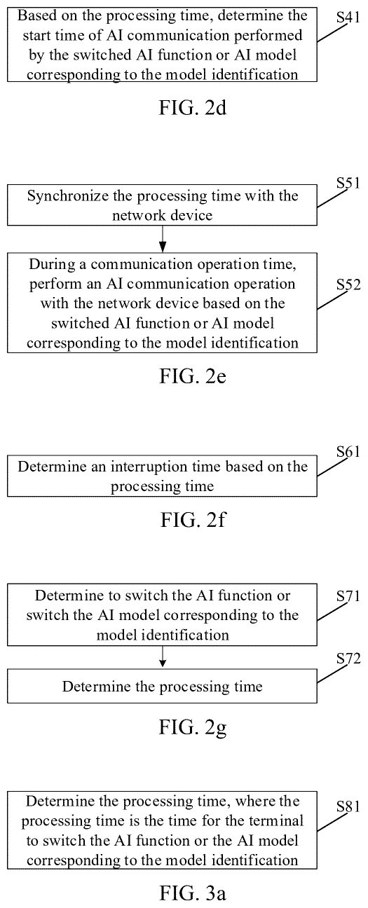

FIG. 2a is a flowchart of an AI communication method according to an exemplary embodiment. As shown in FIG. 2a, the AI communication method is performed by a terminal and includes the following steps.

In step S11, a processing time is determined, where the processing time is the time for switching an AI function or switching an AI model corresponding to a model identification.

In step S12, the AI function or the AI model corresponding to the model identification is switched based on the processing time.

In the embodiments of the present disclosure, the processing time for switching the AI function or the AI model corresponding to the model identification is determined, and the switching time corresponding to switching the AI function or the AI model corresponding to the model identification is clarified.

In the AI communication method provided in the embodiments of the present disclosure, AI function switching can be understood as switching between different AI functions. The switching of AI model corresponding to model identification can be understood as switching between AI models corresponding to different model identifications. The AI models corresponding to different model identifications can be understood as different AI models under the same model identification, or can be understood as different AI models corresponding to different model identifications.

In one implementation of the AI communication method provided by the embodiments of the present disclosure, the processing time for switching different AI functions or AI models corresponding to different model identifications is the same.

In one implementation of the embodiments of the present disclosure, the terminal may determine that the processing time for switching different AI functions is the same, and determine the time for switching different AI functions as the same processing time, to simplify the processing of switching different AI functions.

It is understandable that the processing time used for switching different AI functions may be objectively different. In some scenarios, in order to simplify processing, the processing time of different AI functions can be defined as the same processing time. For example: when the difference in the processing time of different AI functions is less than a certain time threshold, it can be determined that the processing time of the different AI functions is the same.

Exemplarily, the different AI functions to be switched include AI function #1, AI function #2, and AI function #3. In the embodiments of the present disclosure, the time for switching different AI functions is defined as the same time T1. Therefore, the processing time for switching between AI function #3 and AI function #1 is T1. The processing time for switching between AI function #3 and AI function #2 is T1. The processing time for switching between AI function #2 and AI function #1 is T1.

In one implementation of the embodiments of the present disclosure, the same processing time for switching different AI functions may be predefined by a protocol, or the same processing time for switching different AI functions may be configured based on a network device.

In one implementation of the embodiments of the present disclosure, the terminal may determine that the processing time for switching the AI models corresponding to different model identifications is the same, and determine the time for switching the AI models corresponding to different model identifications to be the same processing time, so as to simplify the processing for switching the AI models corresponding to different model identifications.

Exemplarily, the AI models corresponding to different model identifications to be switched include the physical model m1 corresponding to the model identification M, the physical model n1 corresponding to the model identification N, and the physical model 11 corresponding to the model identification L (it can be understood that M, N and L are different, and the physical model m1, the physical model n1 and the physical model 11 may be the same or different). In the embodiments of the present disclosure, the time for the AI models corresponding to different model identifications is defined as the same time T2. Therefore, the processing time for switching between the physical model m1 corresponding to the model identification M and the physical model n1 corresponding to the model identification N is T2, the processing time for switching between the physical model n1 corresponding to the model identification N and the physical model 11 corresponding to the model identification L is T2, and the processing time for switching between the physical model m1 corresponding to the model identification M and the physical model 11 corresponding to the model identification L is T2.

In the AI communication method provided by the embodiments of the present disclosure, the same processing time for switching AI models corresponding to different model identifications may be predefined by a protocol. Alternatively, the same processing time for switching AI models corresponding to different model identifications may be configured based on a network device.

In the AI communication method provided in the embodiments of the present disclosure, for switching of different AI functions or switching of AI models corresponding to different model identifications, the situation where the switching time is the same is clarified.

In the embodiments of the present disclosure, the same processing time is predefined based on the protocol or the same processing time is configured based on a network.

In another implementation of the AI communication method provided by the present disclosure, different AI functions or AI models corresponding to different model identifications have different processing time for switching, to adapt to the switching processing of AI functions or AI models with different association relationships.

The association relationship may be determined by whether the same AI model is used. For example, if two AI functions use the same AI model, it is determined that the two AI functions have the association relationship. Alternatively, if the model identifications corresponding to two logical AI models use the same physical AI model, it is determined that the two logical AI models have the association relationship.

Different AI functions that are switched may or may not have the association relationship. The terminal may determine that different AI functions have different processing time for switching.

Exemplarily, switching is performed for different AI functions, AI function #1, AI function #2, and AI function #3. Among them, AI function #1 and AI function #2 use the same AI model and have an association relationship. AI function #1 and AI function #3 use different AI models and have no association relationship. In the embodiment of the present disclosure, different processing time for switching different AI functions is defined. The processing time for switching between AI function #1 and AI function #2 is T3. The processing time for switching between AI function #1 and AI function #3 is T4, and T3 is not equal to T4.

There may be an association relationship between different AI models that are switched, or there may be no association relationship between different AI models that are switched. In one implementation of the embodiments of the present disclosure, the terminal may determine that the processing time for switching the AI models corresponding to different model identifications is different.

Exemplarily, the switching of AI models corresponding to different model identifications may include that the model identification switching causes a change in the physical model, that is, there is no association relationship between the AI models before and after the switching. The switching of AI models corresponding to different model identifications may include that the model identification switching does not cause a change in the physical model, that is, there is an association relationship between the AI models before and after the switching. For example, taking the model identification M/model identification N and the model identification O as an example, the M identification also corresponds to the physical model m1, the identification N corresponds to the physical model n1, and identification O corresponds to the physical model m1. Among them, the physical model used by the model identification O is the same as that used by the model identification M, and they have an association relationship. The physical models used by the model identification M and the model identification N are different, and they do not have an association relationship. In the embodiments of the present disclosure, the processing time of switching of the AI models corresponding to different model identifications is defined to be different. The switching between the model identification M and the model identification O is T5, and the switching between the model identification M and the model identification N is T6. T5 is not equal to T6.

It can be understood that, based on the description of the above embodiments, the situations corresponding to switching of different AI functions or AI models corresponding to different model identifications have been explained. Here, the situations similar to the above situations will not be described one by one.

In the AI communication method provided in the embodiments of the present disclosure, for switching of different AI functions or AI models corresponding to different model identifications, the situation where the switching time is different is clarified.

In the AI communication method provided in the embodiments of the present disclosure, the terminal reports the processing time for switching different AI functions or the processing time for switching AI models corresponding to different model identifications to the network device, so that the network device determines the processing time for switching different AI functions or the processing time for switching AI models corresponding to different model identifications.

FIG. 2b is a flowchart of another AI communication method according to an exemplary embodiment. In one implementation of the embodiments of the present disclosure, as shown in FIG. 2b, the method includes the following steps.

In step S21, first information is sent.

In an embodiment of the present disclosure, the first information is used to indicate the network device to determine the processing time for switching different AI functions or the processing time for switching AI models corresponding to different model identifications.

In an embodiment of the present disclosure, the terminal sends the first information to the network device, to indicate the processing time of different AI functions or the processing time for switching AI models corresponding to different model identifications through the first information, thereby enabling the network device to determine the processing time of switching different AI functions or the processing time of switching AI models corresponding to different model identifications.

In one implementation of the AI communication method of the embodiments of the present disclosure, the first information may explicitly indicate the processing time for switching different AI functions or AI models corresponding to different model identifications, or may implicitly indicate the processing time for switching different AI functions or AI models corresponding to different model identifications.

In one implementation of the AI communication method provided in the embodiments of the present disclosure, the first information includes at least one of the following (i) and (ii):
(i) The processing time for switching different AI functions or AI models corresponding to different model identifications.

In the embodiment of the present disclosure, the processing time included in the first information may be predefined based on a protocol or configured based on the network device.

Exemplarily, when predefined based on a protocol, the protocol may predefine multiple optional values, such as 1 millisecond, 2 milliseconds, and 3 milliseconds, etc. The terminal may report according to the predefined optional values according to a given selection rule.

Exemplarily, the terminal may report the switching time T1 between AI function #1 and AI function #2, and the switching time T2 between AI function #1 and AI function #3.
(2) The association relationship between switching of different AI functions or AI models corresponding to different model identifications.

The association relationship involved in the embodiments of the present disclosure is used to determine the processing time of switching different AI functions, or to determine the processing time of switching the AI models corresponding to different model identifications.

In the embodiments of the present disclosure, the scenarios corresponding to having the association relationship may include at least one of the following: multiple AI functions use the same AI model, or multiple logical models use the same physical model. Each logical model corresponds to one model identification, and the logical model involved below can be used interchangeably with the logical identification.

For example, the model corresponding to implementing function 1 # is A, the model corresponding to implementing function 2 # is B, and the model corresponding to implementing function 3 # is B. Model A is different from model B. Based on this, it can be known that function 2 # and function 3 # are different functions, but both function 2 # and function 3 # are implemented by model B, that is, it can be determined that function 2 # and function 3 # have an association relationship. Furthermore, function 1 # and function 2 # are different functions, and function 1 # is implemented by model A, and function 2 # is implemented by model B, that is, it can be determined that function 1 # and function 2 # have no association relationship.

It can be understood that the logical model M1 corresponds to using the physical model m1, the logical model M2 corresponds to using the physical model m2, and the logical model M3 corresponds to using the physical model m2, where the physical model m1 is different from the physical model m2. Based on this, it can be known that the logical model M2 and the logical model M3 both use the physical model m2, so the logical model M2 and the logical model M3 have an association relationship, while the physical model used by the logical model M1 is m1, and the physical model used is different from the logical model M2, so the logical model M1 and the logical model M2 have no association relationship.

In an embodiment of the present disclosure, after determining the association relationship for switching AI functions or AI models corresponding to different model identifications, the terminal can report the association relationship to the network device, and the network device determines the processing time based on the acquired association relationship.

The processing time used for switching different AI functions with the association relationship is different from the processing time used for switching different AI functions without the association relationship.

The processing time for switching between AI models corresponding to different model identifications with the association relationship is different from the processing time for switching between AI models corresponding to different model identifications without the association relationship.

It is understandable that the terminal may pre-store the corresponding processing time mapping relationship between different functions or AI models corresponding to different model identifications.

It is understandable that in some scenarios, the processing time corresponding to the switching of AI functions with the association relationship and the switching of model identifications with the association relationship may be 0.

Exemplarily, the terminal and the network device pre-store different AI functions with the association relationship, and AI models corresponding to different model identifications with the association relationship. The terminal can report which AI functions have the association relationship based on whether different AI functions have the association relationship. When switching is required, the terminal reports the AI functions before and after the switching, so that after receiving the switching between the AI functions reported by the terminal, the network device can determine whether the AI functions before and after the switching are switching between AI functions with the association relationship or switching between AI functions without the association relationship. Then, based on the mapping relationship between the AI functions with the association relationship and the switching time, and the mapping relationship between the AI functions without the association relationship and the switching time, the processing time of the switching is determined.

In one example, since the models corresponding to the AI functions having the association relationship are the same, even if the AI function is switched, the model used will not be switched, so the switching time can be 0.

In one example, the AI functions without the association relationship correspond to different models, and switching of the AI functions results in switching of the used models, so the switching time is greater than 0.

In the embodiment of the present disclosure, the switching time when the AI functions with the association relationship are switched is shorter than the switching time of the AI functions without the association relationship.

FIG. 2c is a flowchart of another AI communication method according to an exemplary embodiment. In one implementation of the embodiments of the present disclosure, as shown in FIG. 2c, the terminal can enable the network device to determine the processing time for switching different AI functions or the processing time for switching AI models with different model identifications in the following manner.

In step S31, the terminal reports the processing time of switching different AI functions or the processing time of switching AI models with different model identifications.

In an embodiment of the present disclosure, the network device can determine the processing time for switching different AI functions or the processing time for switching AI models with different model identifications based on the processing time reported by the terminal.

In the embodiment of the present disclosure, the network device can perform conversion processing on the processing time reported by the terminal, to convert the processing time reported by the terminal to the time for communication processing between the terminal and the network device. For example, the time may be the time represented by the communication time unit in the communication system.

Exemplarily, the network device determines the representation form of the processing time when switching the AI function or AI model in the communication system based on the representation form of the processing time reported by the terminal.

Exemplarily, the representation form of the processing time determined by the network device may be a representation form based on the communication time unit. The representation form of the processing time reported by the terminal may be a representation form of absolute time, communication time unit, and AI time unit. For example, if the processing time reported by the terminal is 0.5 milliseconds, the corresponding processing time determined by the network device may be 1 OFDM symbol.

In the embodiments of the present disclosure, the terminal may determine the time for subsequent communication processing based on the determined processing time of switching different AI functions or the processing time of switching AI models with different model identifications. For example, the time of the communication processing may be the start time of the AI communication performed by the switched AI function or AI model corresponding to the model identification. For another example, the time of the communication processing may be the time for the AI communication operation to be performed based on the switched AI function or AI model corresponding to the model identification.

FIG. 2d is a flowchart of another AI communication method according to an exemplary embodiment. In one implementation of the embodiments of the present disclosure, as shown in FIG. 2d, the terminal may determine the start time of AI communication performed by the switched AI function or AI model corresponding to the model identification in the following manner.

In step S41: based on the processing time, the start time of AI communication performed by the switched AI function or AI model corresponding to the model identification is determined.

In the embodiment of the present disclosure, the processing time may be the processing time reported by the terminal or the processing time determined by the network device.

For example, the switching time between AI function #1 and AI function #2 is X time unit(s). Based on the X time unit(s), the terminal can determine that AI function #2 will take effect after Z time unit(s). Z is determined based on X, and Z is the start time. For example, in AI-based beam management, AI function #1 is switched to AI function #2, and AI function #2 requires the terminal to send the ID of the predicted best beam and the measurement result of the best beam. At this time, the terminal will feed back the best beam ID and the measurement result corresponding to the best beam at the earliest after Z time units.

FIG. 2e is a flowchart of another AI communication method according to an exemplary embodiment. In one implementation of the embodiments of the present disclosure, as shown in FIG. 2e, the terminal can enable the network device to determine the time for performing the AI communication operation based on the switched AI function or AI model corresponding to the model identification in the following manner.

In step S51: the processing time is synchronized with the network device.

In step S52: during a communication operation time, an AI communication operation is performed with the network device based on the switched AI function or AI model corresponding to the model identification. The communication operation time is the time for the AI communication operation determined based on the processing time.

Exemplarily, the time for performing an AI communication operation based on the switched AI function or AI model corresponding to the model identification may be the time for the network device to perform an AI communication operation based on the switched AI function or AI model corresponding to the model identification. For example, the network device sends a command to indicate the time for the terminal to perform an AI operation. In this case, the terminal synchronizes the processing time of switching different AI functions or the processing time of switching AI models with different model identifications with the network device, so that the network device determines the time for performing an AI communication operation based on the switched AI function or AI model corresponding to the model identification.

For example, if the switching time between AI function #1 and AI function #2 is X time units, then based on X time units, the network can determine that it can send the command to the terminal to perform the corresponding AI operation after Z time units. For example, in AI-based positioning, if AI function #1 is switched to AI function #2, the network can only send a positioning request based on AI function #2 after Z time units.

FIG. 2f is a flowchart of another AI communication method according to an exemplary embodiment. An implementation of the AI communication method provided by the embodiments of the present disclosure is shown in FIG. 2f. The terminal can determine the interruption time in the following manner.

In step S61: based on the processing time, an interruption time is determined, where the interruption time is used to indicate the time when the terminal cannot perform AI communication.

In the embodiment of the present disclosure, the interruption time may be greater than the processing time, or may be equal to the processing time.

In one implementation of the embodiments of the present disclosure, during the interruption time, the terminal may perform the following operations: communicating in a non-AI mode; or the terminal discarding the AI operation unfinished by the AI function or the AI model corresponding to the model identification before switching.

Exemplarily, the communication operation is performed based on a non-AI method during the interruption time.

It is understandable that the terminal may select the non-AI mode for communication based on setting of a given rule.

FIG. 2g is a flowchart of another AI communication method according to an exemplary embodiment. In one implementation of the AI communication method, as shown in FIG. 2g, the terminal may determine the processing time through the following steps.

In step S71: it is determined that the AI function needs to be switched or it is determined that the AI model corresponding to the model identification needs to be switched.

In step S72, based on determining that the AI function needs to be switched or determining that the AI model corresponding to the model identification needs to be switched, the processing time is determined.

In an embodiment of the present disclosure, the terminal may determine the processing time when determining that the AI function needs to be switched or determining that the AI model corresponding to the model identification needs to be switched.

In one implementation of the embodiments of the present disclosure, it is determined to switch the AI function or the AI model corresponding to the model identification based on a given rule.

In one implementation of the embodiments of the present disclosure, the given rule includes a change in a Radio Resource Control (RRC) parameter.

Exemplarily, AI function #1 supports running when the RRC parameter is configured as X, and AI function #2 supports running when the RRC parameter is configured as Y. When the network device reconfigures the RRC parameter from X to Y, the AI function running on the terminal side also switches from function #1 to function #2.

It should be noted that those skilled in the art can understand that the various implementations/embodiments involved in the embodiments of the present disclosure can be used in conjunction with the aforementioned embodiments or can be used independently. Whether used alone or in conjunction with the aforementioned embodiments, the implementation principle is similar. In the implementation of the present disclosure, some embodiments are described in terms of implementations used together. Those skilled in the art can understand that such examples are not limitations of the embodiments of the present disclosure.

Based on the same concept, the embodiment of the present disclosure also provides an AI communication method.

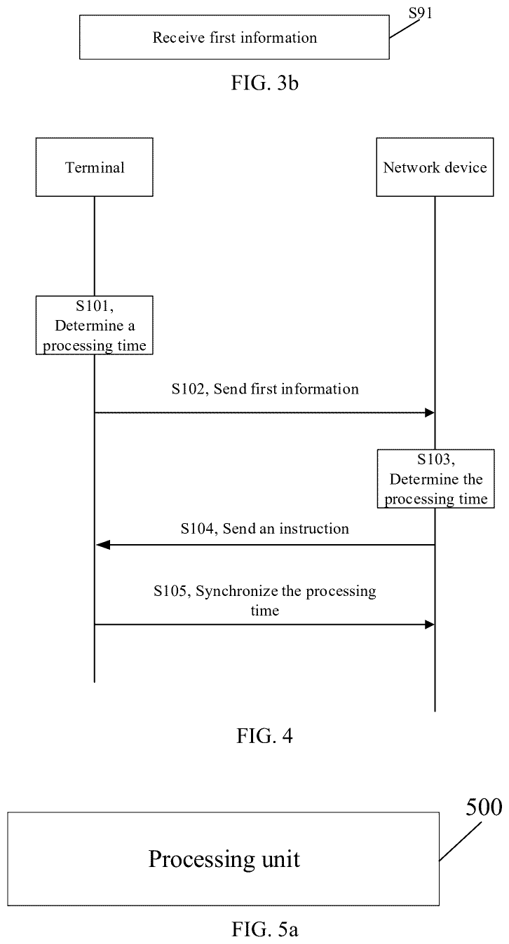

FIG. 3a is a flowchart of an AI communication method according to an exemplary embodiment. As shown in FIG. 3a, the AI communication method is performed by a network device. The AI communication method includes the following steps.

In step S81, the processing time is determined, where the processing time is the time it takes for the terminal to switch the AI function or the AI model corresponding to the model identification.

In the AI communication method provided in the embodiments of the present disclosure, AI function switching can be understood as switching between different AI functions. The switching of AI model corresponding to the model identification can be understood as switching between AI models corresponding to different model identifications. The AI models corresponding to different model identifications can be understood as different AI models under the same model identification, or can be understood as different AI models corresponding to different model identifications.

In the embodiments of the present disclosure, the scenarios in which the network device switches between different AI functions or AI models corresponding to different model identifications are similar. Therefore, for the scenarios in which the processing time for switching different AI functions or AI models corresponding to different model identifications is the same, the relevant description in the embodiments of the above-mentioned terminal device may be referred to, which will not be repeated here. In one implementation of the embodiment of the present disclosure, the processing time for switching different AI functions or AI models corresponding to different model identifications is the same.

In one implementation of the embodiments of the present disclosure, the same processing time for switching different AI functions may be predefined by a protocol. Alternatively, the same processing time for switching different AI functions may be configured based on the network device. In one implementation of the embodiments of the present disclosure, different AI functions or AI models corresponding to different model identifications have different processing time for switching.

FIG. 3b is a flowchart of another AI communication method according to an exemplary embodiment. In one implementation of the embodiments of the present disclosure, as shown in FIG. 3b, the method includes the following steps.

In step S91, first information is received.

In an embodiment of the present disclosure, the first information is used to indicate the network device to determine the processing time for switching different AI functions or the processing time for switching AI models corresponding to different model identifications.

In one implementation of the embodiments of the present disclosure, the first information may explicitly indicate the processing time for switching different AI functions or AI models corresponding to different model identifications, or may implicitly indicate the processing time for switching different AI functions or AI models corresponding to different model identifications.

In one implementation of the AI communication method provided by the embodiments of the present disclosure, the first information includes a processing time for switching different AI functions or AI models corresponding to different model identifications; and/or the first information includes an association relationship between switching different AI functions or AI models corresponding to different model identifications;
the processing time for switching different AI functions or AI models corresponding to different model identifications with the association relationship is different from the processing time for switching different AI functions or AI models corresponding to different model identifications without the association relationship.

It is understandable that the network device may pre-store the corresponding processing time mapping relationship between different functions or AI models corresponding to different model identifications. Taking function switching as an example, when performing function switching, the terminal reports the AI functions before and after the switching. When the network device receives the AI functions before and after the switching reported by the terminal, it can determine the situation corresponding to the AI function switching according to the mapping relationship (switching between AI functions with the association relationship or switching between AI functions without the association relationship), thereby determining the processing time.

It can be understood that, for the switching of AI functions with an association relationship or the switching of model identifications with an association relationship, since the switching process is not accompanied by the switching of AI models, the processing time of the switching of AI functions with the association relationship is shorter than the processing time of the switching of AI functions without the association relationship; the processing time of the switching of model identifications with the association relationship is shorter than the processing time of the switching of AI functions without the association relationship.

It is understandable that in some scenarios, the processing time corresponding to the switching of AI functions with the association relationship and the switching of model identifications with the association relationship may be 0.

In the embodiments of the present disclosure, the definition and description of the association relationship are similar to the definition and description of the association relationship in the terminal device. Therefore, the relevant description can refer to the description in the above-mentioned embodiments of the terminal device, and will not be repeated here.

In one implementation of the embodiments of the present disclosure, the method further includes: determining, based on the processing time, a time for performing an AI communication operation based on the switched AI function or AI model corresponding to the model identification; and performing an AI communication operation with the terminal based on the switched AI function or AI model corresponding to the model identification during the communication operation time. The communication operation time is the time for the AI communication operation determined based on the processing time.

In the embodiment of the present disclosure, the processing time may be the processing time reported by the terminal or the processing time determined by the network device.

In one implementation of the embodiments of the present disclosure, the method further includes: determining an interruption time based on the processing time, where the interruption time is used to indicate a time when the terminal cannot perform AI communication.

In one implementation of the embodiments of the present disclosure, the terminal being unable to perform AI communication includes: the terminal communicating based on a non-AI mode; or the terminal discarding an AI operation unfinished by the AI function or the AI model corresponding to the model identification before switching.

In one implementation of the embodiments of the present disclosure, the method further includes: sending a switching command, where the switching command is used to indicate the terminal to determine to switch the AI function or the AI model corresponding to the model identification.

In one implementation of the embodiments of the present disclosure, the switching of the AI function or the AI model corresponding to the model identification is determined based on a given rule.

In one implementation of the embodiments of the present disclosure, the given rule includes a change in an RRC parameter.

It can be understood that the implementation process of the AI communication method performed by the network device in the embodiments of the present disclosure is similar to that of the AI communication method performed by the terminal device. The similarities will not be repeated here, and reference can be made to the implementation process of the AI communication method performed by the terminal device mentioned above.

Based on the same concept, the embodiment of the present disclosure also provides an AI communication system. The AI communication system includes a terminal device and a network device. The terminal device and the network device interact to implement an AI communication method.

FIG. 4 is a schematic diagram of a method interaction of an AI communication system shown in an exemplary embodiment of the present disclosure. As shown in FIG. 4, the embodiment of the present disclosure relates to an AI communication system, and the method includes the following steps.

In step S101: a processing time is determined.

In one implementation, the processing time is the time for switching the AI function or the AI model corresponding to the model identification.

In one implementation, different AI functions or AI models corresponding to different model identifications have the same processing time for switching.

In one implementation, the processing time is predefined based on a protocol; or the processing time is configured based on a network device.

In one implementation, different AI functions or AI models corresponding to different model identifications have different processing times for switching.

In step S102: first information is sent.

In one implementation, the first information is used for the network device to determine the processing time for switching the AI function or the AI model corresponding to the model identification.

In one implementation, the first information may explicitly indicate the processing time for switching different AI functions or AI models corresponding to different model identifications, or may implicitly indicate the processing time for switching different AI functions or AI models corresponding to different model identifications.

In step S103: the processing time is determined.

In one implementation, based on the processing time reported by the terminal, the processing time for switching different AI functions or the processing time for switching AI models with different model identifications is determined.

In one implementation, the network device may perform conversion processing on the processing time reported by the terminal, to convert the processing time reported by the terminal into the time for communication processing between the terminal and the network device.

In one implementation, the processing time is the time it takes for the terminal to switch the AI function or the AI model corresponding to the model identification.

In one implementation, different AI functions or AI models corresponding to different model identifications have the same processing time for switching.

In one implementation, the processing time is predefined based on a protocol; or the processing time is configured based on a network device.

In one implementation, different AI functions or AI models corresponding to different model identifications have different processing time for switching.

In step S104: a command is sent to indicate to the terminal the time to perform the AI operation.

In one implementation, the network device sends a command to indicate the terminal when to perform the AI operation.

In step S105, the processing time is synchronized.

In one implementation, the terminal synchronizes with the network device the processing time of switching different AI functions or the processing time of switching AI models with different model identifications, so that the network device determines the time for performing the AI communication operation based on the switched AI function or AI model corresponding to the model identification.

The positioning measurement method involved in the embodiments of the present disclosure may include at least one of steps S101 to S105. For example, step S101 can be implemented as an independent embodiment, step S103 can be implemented as an independent embodiment, step S101+step S102 can be implemented as an independent embodiment, and step S101+step S102+step S103 can be implemented as independent embodiments, but are not limited thereto. In some embodiments, steps S102 and S103 can be exchanged in order or executed simultaneously, and steps S101 and S104 can be exchanged in order or executed simultaneously. In some embodiments, steps Step S101, step S104 and step S105 are optional, and one or more of these steps may be omitted or replaced in different embodiments.

In the embodiments of the present disclosure, the implementation process involved in the network device performing the AI communication method is the same or similar to the implementation process in the terminal performing the AI communication method. Based on this, for the information processing process related to the network device, the relevant embodiments of the above-mentioned terminal may be referred to, and the embodiments of the present disclosure will not be repeated here one by one.

The AI communication method provided in the embodiments of the present disclosure is applicable to the implementation process of interaction between a terminal and a network device in a communication system.

Based on the same concept, an embodiment of the present disclosure provides a communication system, which includes a terminal and a network device that performs the above-mentioned AI communication method.

In the embodiment of the present disclosure, in the interaction scenario between the terminal and the network device, the relevant information processing process of the network device in the interaction scenario is the same or similar to that of the terminal in the interaction scenario. Based on this, for the relevant information processing process of the network device in the interaction scenario, reference can be made to the relevant embodiments of the above-mentioned terminal, and the embodiments of the present disclosure will not be repeated here one by one.

Based on the same concept, the embodiment of the present disclosure also provides an AI communication apparatus.

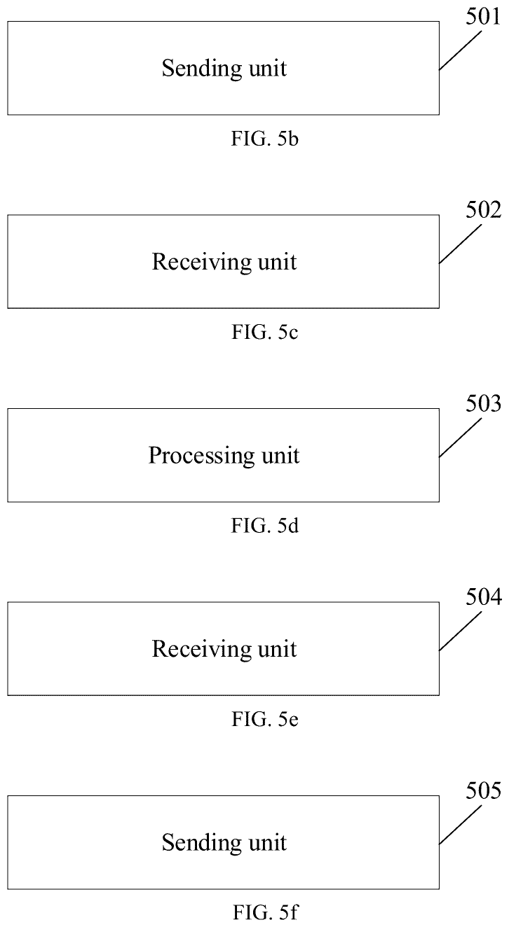

FIG. 5a is a structural block diagram of an AI communication apparatus according to an exemplary embodiment, where the AI communication apparatus is executed by a terminal.

As shown in FIG. 5a, an embodiment of the present disclosure provides an AI communication apparatus, including: a processing unit 500, configured to determine a processing time, the processing time being the time for switching the AI function or the AI model corresponding to the model identification; based on the processing time, switch the AI function or the AI model corresponding to the model identification.

In one implementation, different AI functions or AI models corresponding to different model identifications have the same processing time for switching.

In one implementation, the processing time is predefined based on a protocol; or the processing time is configured based on a network device.

In one implementation, different AI functions or AI models corresponding to different model identifications have different processing time for switching.

FIG. 5b is a structural block diagram of another AI communication apparatus according to an exemplary embodiment. In one implementation, as shown in FIG. 5b, the AI communication apparatus further includes a sending unit 501, where the sending unit 501 is configured to send first information, and the first information is configured to indicate the network device to determine the processing time of switching the AI function or the AI model corresponding to the model identification.

In one implementation, the first information includes the processing time for switching different AI functions or AI models corresponding to different model identifications; and/or the first information includes the association relationship between switching different AI functions or AI models corresponding to different model identifications; where the processing time for switching different AI functions or AI models corresponding to different model identifications with an association relationship is different from the processing time for switching different AI functions or AI models corresponding to different model identifications without an association relationship.

In one implementation, the processing unit 500 switches the AI function or AI model corresponding to the model identification based on the processing time in the following manner: determining the start time for performing AI communication by the switched AI function or the AI model corresponding to the model identification based on the processing time.

In one implementation, the processing unit 500 is further configured to synchronize the processing time with the network device; during the communication operation time, perform an AI communication operation with the network device based on the switched AI function or AI model corresponding to the model identification, where the communication operation time is the time for the AI communication operation determined based on the processing time.

In one implementation, the processing unit 500 is further configured to determine an interruption time based on the processing time, where the interruption time is a time during which the terminal cannot perform AI communication.

In one implementation, during the interruption time, the terminal communicates based on a non-AI mode; or the terminal discards an unfinished AI operation of the AI function or the AI model corresponding to the model identification before switching.

FIG. 5c is a structural block diagram of another AI communication apparatus according to an exemplary embodiment. In one implementation, the AI communication apparatus shown in FIG. 5c further includes a receiving unit, and the receiving unit 502 is further configured to receive a switching command, and the switching command is used to indicate the terminal to switch the AI function or the AI model corresponding to the model identification.

In one implementation, the processing unit 500 is further configured to determine to switch the AI function or the AI model corresponding to the model identification based on a given rule.

In one implementation, the given rule includes a change in an RRC parameter.

Based on the same concept, the embodiment of the present disclosure also provides an AI communication apparatus.

FIG. 5d is a structural block diagram of an AI communication apparatus according to an exemplary embodiment, where the AI communication apparatus is performed by a network device.

As shown in FIG. 5d, an embodiment of the present disclosure provides an AI communication apparatus, including: a processing unit 503, configured to determine a processing time, where the processing time is the time for a terminal to switch an AI function or an AI model corresponding to a model identification.

In one implementation, different AI functions or AI models corresponding to different model identifications have the same processing time for switching.

In one implementation, the processing time is predefined based on a protocol; or the processing time is configured based on a network device.

In one implementation, different AI functions or AI models corresponding to different model identifications have different processing time for switching.

FIG. 5e is a structural block diagram of another AI communication apparatus according to an exemplary embodiment. In one implementation, the AI communication apparatus further includes a receiving unit, the receiving unit 504 is configured to receive first information, the first information is used to indicate the network device to determine the processing time for switching the AI function or the AI model corresponding to the model identification.

In one implementation, the first information includes the processing time for switching different AI functions or AI models corresponding to different model identifications; and/or the first information includes the association relationship between the switching of the different AI functions or AI models corresponding to different model identifications; where the processing time for switching different AI functions or AI models corresponding to different model identifications with the association relationship is different from the processing time for switching different AI functions or AI models corresponding to different model identifications that have no association relationship.

In one implementation, the processing unit 503 is also configured to determine, based on the processing time, a time for performing an AI communication operation based on the switched AI function or AI model corresponding to the model identification; and during the communication operation time, perform an AI communication operation with the terminal based on the switched AI function or AI model corresponding to the model identification, where the communication operation time is the time for the AI communication operation determined based on the processing time.

In one implementation, the processing unit 503 is further configured to determine an interruption time based on the processing time, where the interruption time is used to indicate a time when the terminal is unable to perform AI communication.

In one implementation, the terminal being unable to perform AI communication includes: the terminal communicating based on a non-AI mode; or the terminal discarding an uncompleted AI operation of the AI function or the AI model corresponding to the model identification before switching.

FIG. 5f is a structural block diagram of another AI communication apparatus according to an exemplary embodiment. In one implementation, as shown in FIG. 5f, the AI communication apparatus further includes a sending unit 505, which is configured to send a switching command, where the switching command is used to indicate the terminal to determine to switch the AI function or the AI model corresponding to the model identification.

In one implementation, the processing unit is further configured to: determine to switch the AI function or the AI model corresponding to the model identification based on a given rule.

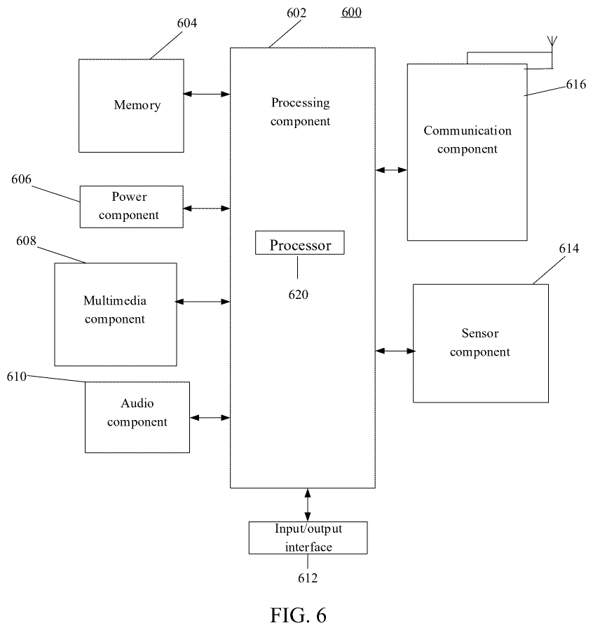

In one implementation, the given rule includes a change in a radio resource control RRC parameter. FIG. 6 is a block diagram of an apparatus 600 for communication according to an exemplary embodiment. For example, the apparatus 600 may be a mobile phone, a computer, a digital broadcast terminal, a messaging device, a game console, a tablet device, a medical device, a fitness device, a personal digital assistant, etc.

Referring to FIG. 6, the apparatus 600 may include one or more of the following components: a processing component 602, a memory 604, a power component 606, a multimedia component 608, an audio component 610, an input/output (I/O) interface 612, a sensor component 614, and a communication component 616.

The processing component 602 generally controls the overall operation of the apparatus 600, such as operations associated with display, phone calls, data communications, camera operations, and recording operations. The processing component 602 may include one or more processors 620 to execute instructions to complete all or part of the steps of the above-mentioned methods. In addition, the processing component 602 may include one or more modules to facilitate the interaction between the processing component 602 and other components. For example, the processing component 602 may include a multimedia module to facilitate the interaction between the multimedia component 608 and the processing component 602.

The memory 604 is configured to store various types of data to support operations on the apparatus 600. Examples of such data include instructions for any application or method operating on the apparatus 600, contact data, phone book data, messages, pictures, videos, etc. The memory 604 can be implemented by any type of volatile or non-volatile storage device or a combination thereof, such as a static random access memory (SRAM), an electrically erasable programmable read-only memory (EEPROM), an Erasable Programmable Read-Only Memory (EPROM), a Programmable Read-Only Memory (PROM), a Read-Only Memory (ROM), a magnetic memory, a flash memory, a magnetic or optical magnetic disk.

The power component 606 provides power to the various components of the apparatus 600. The power component 606 may include a power management system, one or more power supplies, and other components associated with generating, managing, and distributing power for the apparatus 600.

The multimedia component 608 includes a screen that provides an output interface between the apparatus 600 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, swipe, and gestures on the touch panel. The touch sensor may not only sense the boundaries of the touch or swipe action, but also detect the duration and pressure associated with the touch or swipe operation. In some embodiments, the multimedia component 608 includes a front camera and/or a rear camera. When the apparatus 600 is in an operating mode, such as a shooting mode or a video mode, the front camera and/or the rear camera may receive external multimedia data. Each front camera and rear camera may be a fixed optical lens system or have a focal length and optical zoom capability.

The audio component 610 is configured to output and/or input audio signals. For example, the audio component 610 includes a microphone (MIC), and when the apparatus 600 is in an operating mode, such as a call mode, a recording mode, and a speech recognition mode, the microphone is configured to receive an external audio signal. The received audio signal can be further stored in the memory 604 or sent via the communication component 616. In some embodiments, the audio component 610 also includes a speaker for outputting audio signals.

The I/O interface 612 provides an interface between the processing component 602 and peripheral interface modules, such as keyboards, click wheels, buttons, etc. These buttons may include but are not limited to: a home button, a volume button, a start button, and a lock button.

The sensor assembly 614 includes one or more sensors for providing various aspects of status assessment for the apparatus 600. For example, the sensor assembly 614 can detect the open/closed state of the apparatus 600, the relative positioning of components, such as the display and keypad of the apparatus 600, and the sensor assembly 614 can also detect the position change of the apparatus 600 or a component of the apparatus 600, the presence or absence of user contact with the apparatus 600, the orientation or acceleration/deceleration of the apparatus 600, and the temperature change of the apparatus 600. The sensor assembly 614 may include a proximity sensor configured to detect the presence of a nearby object without any physical contact. The sensor assembly 614 may also include an optical sensor, such as a CMOS or CCD image sensor, for use in imaging applications. In some embodiments, the sensor assembly 614 may also include an accelerometer, a gyroscope sensor, a magnetic sensor, a pressure sensor, or a temperature sensor.

The communication component 616 is configured to facilitate wired or wireless communication between the apparatus 600 and other devices. The apparatus 600 can access a wireless network based on a communication standard, such as WiFi, 2G or 3G, or a combination thereof. In an exemplary embodiment, the communication component 616 receives a broadcast signal or broadcast-related information from an external broadcast management system via a broadcast channel. In an exemplary embodiment, the communication component 616 also includes a near field communication (NFC) module to facilitate short-distance communication. For example, the NFC module can be implemented based on radio frequency identification (RFID) technology, infrared data association (IrDA) technology, ultra-wideband (UWB) technology, Bluetooth (BT) technology and other technologies.

In an exemplary embodiment, the apparatus 600 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components to perform the above methods.

In an exemplary embodiment, a non-transitory computer-readable storage medium including instructions is also provided, such as a memory 604 including instructions, and the instructions can be executed by a processor 620 of the apparatus 600 to perform the above methods. For example, the non-transitory computer-readable storage medium can be a ROM, a random access memory (RAM), a CD-ROM, a magnetic tape, a floppy disk, an optical data storage device, etc.

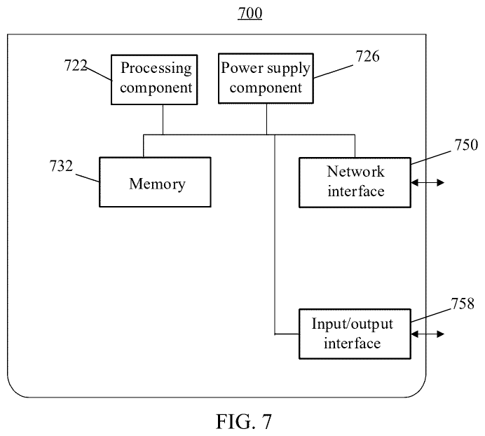

FIG. 7 is a block diagram of an apparatus 700 for communication according to an exemplary embodiment. For example, the apparatus 700 may be provided as a network device. Referring to FIG. 7, the apparatus 700 includes a processing component 722, which further includes one or more processors, and a memory resource represented by a memory 732 for storing instructions executable by the processing component 722, such as an application. The application stored in the memory 732 may include one or more modules, each corresponding to a set of instructions. In addition, the processing component 722 is configured to execute instructions to perform the above methods.

The apparatus 700 may also include a power supply component 726 configured to perform power management of the apparatus 700, a wired or wireless network interface 750 configured to connect the apparatus 700 to a network, and an input/output (I/O) interface 758. The apparatus 700 may operate based on an operating system stored in the memory 732, such as Windows Server™, Mac OS X™, Unix™, Linux™, FreeBSD™, or the like.

In an exemplary embodiment, a non-transitory computer-readable storage medium including instructions is also provided, such as a memory 732 including instructions, and the instructions can be executed by the processing component 722 of the apparatus 700 to perform the above methods. For example, the non-transitory computer-readable storage medium can be a ROM, a random access memory (RAM), a CD-ROM, a magnetic tape, a floppy disk, an optical data storage device, etc.

The embodiments of the present disclosure propose an artificial intelligence communication method, apparatus, and storage medium. In some embodiments, the terms, such as a communication method, an information processing method, a communication method, can be replaced with each other, the terms, such as a communication apparatus, an information processing apparatus, can be replaced with each other, and the terms, such as an information processing system, a communication system, can be replaced with each other.

The technical solutions provided by the embodiments of the present disclosure may include the following beneficial effects: by determining the processing time for switching the AI function or the AI model corresponding to the model identification, the determination of the processing time for switching the AI function or the AI model corresponding to the model identification is achieved. Based on the processing time, the AI function or the AI model corresponding to the model identification is switched, which improves the communication performance based on switching of the AI function or the AI model corresponding to the model identification.

The embodiments of the present disclosure are not exhaustive, but are only illustrative of some embodiments, and are not intended to be a specific limitation on the scope of protection of the present disclosure. In the absence of contradiction, each step in a certain embodiment can be implemented as an independent embodiment, and the steps can be arbitrarily combined. For example, a solution after removing some steps in a certain embodiment can also be implemented as an independent embodiment, and the order of the steps in a certain embodiment can be arbitrarily exchanged. In addition, the optional implementations in a certain embodiment can be arbitrarily combined; in addition, the embodiments can be arbitrarily combined, for example, some or all of the steps of different embodiments can be arbitrarily combined, and a certain embodiment can be arbitrarily combined with the optional implementations of other embodiments.

In each embodiment of the present disclosure, if there is no special explanation and logical conflict, the terms and/or descriptions between the embodiments are consistent and can be referenced to each other, and the technical features in different embodiments can be combined to form a new embodiment according to their inherent logical relationship. The terms used in the embodiments of the present disclosure are only for the purpose of describing specific embodiments, and are not intended to limit the present disclosure.

It is further understood that in the present disclosure, “plurality/multiple” refers to two or more than two, and other quantifiers are similar thereto. “And/or” describes the association relationship of associated objects, indicating that three relationships may exist. For example, A and/or B may represent: A exists alone, A and B exist at the same time, and B exists alone. The character “/” generally indicates that the associated objects before and after are in an “or” relationship. The singular forms “a/an”, “said” and “the” are also intended to include plural forms, unless the context clearly indicates other meanings.

It is further understood that the meanings of the words “in response to” and “if” involved in the present disclosure depend on the context and the actual usage scenario. For example, the word “in response to” used herein can be interpreted as “at ...” or “when ...” or “if”.

It is further understood that the terms “first”, “second”, etc. are used to describe various information, but such information should not be limited to these terms. These terms are only used to distinguish the same type of information from each other, and do not indicate a specific order or degree of importance. In fact, the expressions “first”, “second”, etc. can be used interchangeably. For example, without departing from the scope of the present disclosure, the first information can also be referred to as the second information, and similarly, the second information can also be referred to as the first information.

It is further understood that, although the operations are described in a specific order in the drawings in the embodiments of the present disclosure, it should not be understood as requiring the operations to be performed in the specific order shown or in a serial order, or requiring the execution of all the operations shown to obtain the desired results. In certain environments, multitasking and parallel processing may be advantageous.

Those skilled in the art will readily appreciate other embodiments of the present disclosure after considering the specification and practicing the content disclosed herein. This application is intended to cover any modifications, uses or adaptations of the present disclosure, which follow the general principles of the present disclosure and include common knowledge or customary technical means in the art that are not disclosed in the present disclosure.

It should be understood that the present disclosure is not limited to the precise structures that have been described above and shown in the drawings, and that various modifications and changes may be made without departing from the scope thereof. The scope of the present disclosure is limited only by the scope of the appended claims.

1. An artificial intelligence (AI) communication method, performed by a terminal, the method comprising:
determining a processing time, wherein the processing time is a time for switching an AO function or an AI model corresponding to a model identification; and
switching the AI function or the AI model corresponding to the model identification based on the processing time.

2. The method according to claim 1, wherein the processing time for switching different AI functions or AI models corresponding to different model identifications is the same;
wherein the processing time is predefined based on a protocol; or the processing time is configured based on a network device.

3. (canceled)

4. The method according to claim 1, wherein the processing time for switching different AI functions or AI models corresponding to different model identifications is different.

5. The method according to claim 4, wherein the method comprises:
sending first information, wherein the first information is used to indicate a network device to determine the processing time for switching the AI function or the AI model corresponding to the model identification,
wherein the first information comprises the processing time for switching different AI functions or AI models corresponding to different model identifications; and/or
the first information comprises an association relationship between switching different AI functions or AI models corresponding to different model identifications;
wherein the processing time for switching different AI functions or AI models corresponding to different model identifications with the association relationship is different from the processing time for switching different AI functions or AI models corresponding to different model identifications without the association relationship.

6. (canceled)

7. The method according to claim 1, wherein switching the AI function or the AI model corresponding to the model identification based on the processing time comprises:
determining a start time for performing an AI communication by a switched AI function or AI model corresponding to the model identification based on the processing time.

8. The method according to claim 1, wherein the method further comprises:
synchronizing the processing time with a network device;
during a communication operation time, performing an AI communication operation with the network device based on the switched AI function or AI model corresponding to the model identification, wherein the communication operation time is a time for the AI communication operation determined based on the processing time.

9. The method according to claim 1, wherein the method further comprises:
determining an interruption time based on the processing time, wherein the interruption time is a time during which the terminal is unable to perform an AI communication, and
wherein during the interruption time, the terminal communicates based on a non-AI mode; or the terminal discards an AI operation unfinished by the AI function or the AI model corresponding to the model identification before switching.

10. (canceled)

11. The method according to claim 1, wherein the method further comprises:
receiving a switching command, wherein the switching command is used to indicate the terminal to switch the AI function or the AI model corresponding to the model identification.

12. The method according to claim 1, wherein the method further comprises:
determining to switch the AI function or the AI model corresponding to the model identification based on a given rule, and
wherein the given rule comprises a change in a radio resource control (RRC) parameter.

13. (canceled)

14. An artificial intelligence (AI) communication method, performed by a network device, the method comprising:
determining a processing time, wherein the processing time is a time for a terminal to switch an AI function or an AI model corresponding to a model identification.

15. The method according to claim 14, wherein the processing time for switching different AI functions or AI models corresponding to different model identifications is the same, and
wherein the processing time is predefined based on a protocol; or the processing time is configured based on a network device.

16. (canceled)

17. The method according to claim 14, wherein the processing time for switching the different AI functions or AI models corresponding to different model identifications is different.

18. The method according to claim 17, wherein the method comprises:
receiving first information, wherein the first information is used to indicate the network device to determine the processing time for switching the AI function or the AI model corresponding to the model identification,
wherein the first information comprises the processing time for switching different AI functions or AI models corresponding to different model identifications; and/or
the first information comprises an association relationship between switching different AI functions or AI models corresponding to different model identifications;
wherein the processing time for switching different AI functions or AI models corresponding to different model identifications with the association relationship is different from the processing time for switching different AI functions or AI models corresponding to different model identifications without the association relationship.

19. (canceled)

20. The method according to claim 14, wherein the method further comprises:
determining a time for performing an AI communication operation based on the switched AI function or AI model corresponding to the model identification based on the processing time;
during a communication operation time, performing the AI communication operation with the terminal based on the switched AI function or AI model corresponding to the model identification, wherein the communication operation time is a time for the AI communication operation determined based on the processing time.

21. The method according to claim 14, wherein the method further comprises:
determining an interruption time based on the processing time, wherein the interruption time is used to indicate a time during which the terminal is unable to perform an AI communication,
wherein the terminal being unable to perform the AI communication comprises:
the terminal communicating based on a non-AI mode; or the terminal discarding an AI operation unfinished by the AI function or the AI model corresponding to the model identification before switching.

22. (canceled)

23. The method according to claim 14, wherein the method further comprises:
sending a switching command, wherein the switching command is used to indicate the terminal to determine to switch the AI function or the AI model corresponding to the model identification.

24. The method according to claim 14, wherein the switching of the AI function or the AI model corresponding to the model identification is determined based on a given rule.
wherein the given rule comprises a change in a radio resource control (RRC) parameter.

25-27. (canceled)

28. An artificial intelligence (AI) communication apparatus, comprising:
a processor; and
a memory for storing instructions executable by the processor;
wherein the processor is configured to execute:
determining a processing time, wherein the processing time is a time for switching an AI function or an AI model corresponding to a model identification; and
switching the AI function or the AI model corresponding to the model identification based on the processing time.

29. A storage medium, wherein the storage medium stores instructions, and when the instructions in the storage medium are executed by a processor of a terminal, the terminal is enabled to perform the method according to claim 1.

30. An artificial intelligence (AI) communication apparatus, comprising:
a processor; and
a memory for storing instructions executable by the processor;
wherein the processor is configured to execute the method according to claim 14.
